(19) United States
(12) Patent Application Publication
(10) Pub. No.: US 2022/0212467 A1
(43) Pub. Date: Jul. 7, 2022

(54) LIQUID EJECTING DEVICE

(71) Applicant: SEIKO EPSON CORPORATION, Tokyo (JP)

(72) Inventors: Tomoki SHINODA, Shiojiri-shi (JP); Chikashi NAKAMURA, Azumino-shi (JP); Takeshi IWAMURO, Matsumoto-shi (JP); Yu TSUMURAYA, Ota-ku (JP)

(21) Appl. No.: 17/646,764

(22) Filed: Jan. 3, 2022

(30) Foreign Application Priority Data
Jan. 4, 2021 (JP) 2021-000177

(51) Int. Cl. B41J 2/125; B41J 2/165; B41J 2/175

(52) U.S. Cl. CPC B41J 2/125; B41J 2/16526; B41J 29/38; B41J 2/17566; B41J 2/17596; B41J 2/17509

(57) ABSTRACT

A recording unit configured to ejecting liquid onto a medium in a ejecting direction from a nozzle provided at a nozzle surface to perform recording, a cleaning unit including a first pressing unit and a second pressing unit for cleaning the nozzle surface, and a temperature detection unit configured to detect temperature are included, the nozzle surface includes a first surface in which the nozzle opens and a second surface, and the cleaning unit is configured to perform the cleaning with a distance in the ejecting direction from the first surface set to the first pressing unit or the second pressing unit to a first distance when a detected temperature detected by the temperature detection unit is equal to or greater than a predetermined temperature, and to a second distance shorter than the first distance when the detected temperature is lower than the predetermined temperature.

The present application is based on, and claims priority from JP Application Serial Number 2021-000177, filed Jan. 4, 2021, the disclosure of which is hereby incorporated by reference herein in its entirety.

### BACKGROUND

### 1. Technical Field

The disclosure relates to a liquid ejecting device such as a printer.

### 2. Related Art

For example, as in JP 2017-217857 A, there is a printer, which is an example of a liquid ejecting device that discharges ink, which is an example of liquid, from a recording head, which is an example of a recording unit, and performs printing. The printer includes a wiper for wiping off the recording head, and a temperature sensor, which is an example of a temperature detection unit for detecting temperature.

The wiper, which has elasticity, is cured, and adhesion to the recording head is reduced, when temperature is low. Thus, the printer changes force for pressing the wiper against the recording head, in accordance with temperature detected by the temperature sensor. Specifically, the printer increases force for pressing the wiper against the recording head when the temperature is low, compared to when the temperature is high.

When the temperature is low, viscosity of liquid adhering to a nozzle surface increases compared to when the temperature is high, and it may be difficult to clean the nozzle surface. In particular, when there is unevenness on the nozzle surface, a concaved part of the nozzle surface that is separated from a cleaning unit is less likely to be cleaned, compared to a convex part that is close to the cleaning unit. Therefore, even when the cleaning unit is pressed strongly against the nozzle surface, there is a possibility that the nozzle surface cannot be sufficiently cleaned.

### SUMMARY

A liquid ejecting device that solves the above problem includes a recording unit configured to eject liquid onto a medium in a ejecting direction from a nozzle provided at a nozzle surface to perform recording, a cleaning unit including a pressing unit for cleaning the nozzle surface, and a temperature detection unit configured to detect temperature, wherein the nozzle surface includes a first surface in which the nozzle opens, and a second surface located downstream the first surface in the ejecting direction, and the cleaning unit is configured to perform the cleaning with a distance in the ejecting direction from the first surface to the pressing unit set to a first distance when a detected temperature detected by the temperature detection unit is equal to or greater than a predetermined temperature, and to a second distance shorter than the first distance when the detected temperature is lower than the predetermined temperature.

### BRIEF DESCRIPTION OF THE DRAWINGS

FIG. 1 is a perspective view of Exemplary Embodiment 1 of a liquid ejecting device.

FIG. 2 is a schematic cross-sectional view of a cleaning unit located at a waiting position.

FIG. 3 is a schematic cross-sectional view of the cleaning unit located at the waiting position.

FIG. 4 is a perspective view of a first pressing unit and a second pressing unit.

FIG. 5 is a schematic view of a nozzle surface.

FIG. 6 is a cross-sectional view taken along a line 6-6 in FIG. 5.

FIG. 7 is a schematic cross-sectional view of the cleaning unit for cleaning with the first pressing unit.

FIG. 8 is a schematic cross-sectional view of the cleaning unit after cleaning with the first pressing unit.

FIG. 9 is a schematic cross-sectional view of the cleaning unit for cleaning with the second pressing unit.

FIG. 10 is a schematic cross-sectional view of a recording unit and the second pressing unit.

FIG. 11 is a schematic cross-sectional view of the cleaning unit after cleaning with the second pressing unit.

FIG. 12 is a schematic cross-sectional view of a cleaning unit included in a liquid ejecting device of Exemplary Embodiment 2.

FIG. 13 is a schematic cross-sectional view of a pressing unit for cleaning a recording unit at a high temperature.

FIG. 14 is a schematic cross-sectional view of the pressing unit for cleaning the recording unit at a high temperature.

FIG. 15 is a schematic view illustrating a nozzle surface included in a liquid ejecting device of Exemplary Embodiment 3.

FIG. 16 is a schematic view of a pressing unit.

FIG. 17 is a cross-sectional view taken along a line F17-F17 in FIG. 16.

FIG. 18 is a cross-sectional view taken along a line F18-F18 in FIG. 16.

FIG. 19 is a cross-sectional view of a first convex portion in the pressing unit in a first state.

FIG. 20 is a cross-sectional view of a second convex portion in the pressing unit in the first state.

FIG. 21 is a cross-sectional view of the first convex portion in the pressing unit in a second state.

FIG. 22 is a cross-sectional view of the second convex portion in the pressing unit in the second state.

FIG. 23 is a cross-sectional view of the first convex portion in the pressing unit in a third state.

FIG. 24 is a cross-sectional view of the second convex portion in the pressing unit in the third state.

### DESCRIPTION OF EXEMPLARY EMBODIMENTS

### Exemplary Embodiment 1

Exemplary Embodiment 1 of a liquid ejecting device will be described below with reference to the drawings. The liquid ejecting device is, for example, an ink-ejecting type printer configured to eject ink, which is an example of liquid, onto a medium such as a sheet, to perform printing.

In the drawings, while assuming that a liquid ejecting device 11 is placed on a horizontal surface, a direction of gravity is indicated by a Z-axis, and directions along the horizontal surface are indicated by an X-axis and a Y-axis. The X-, Y-, and Z-axes are orthogonal to each other.

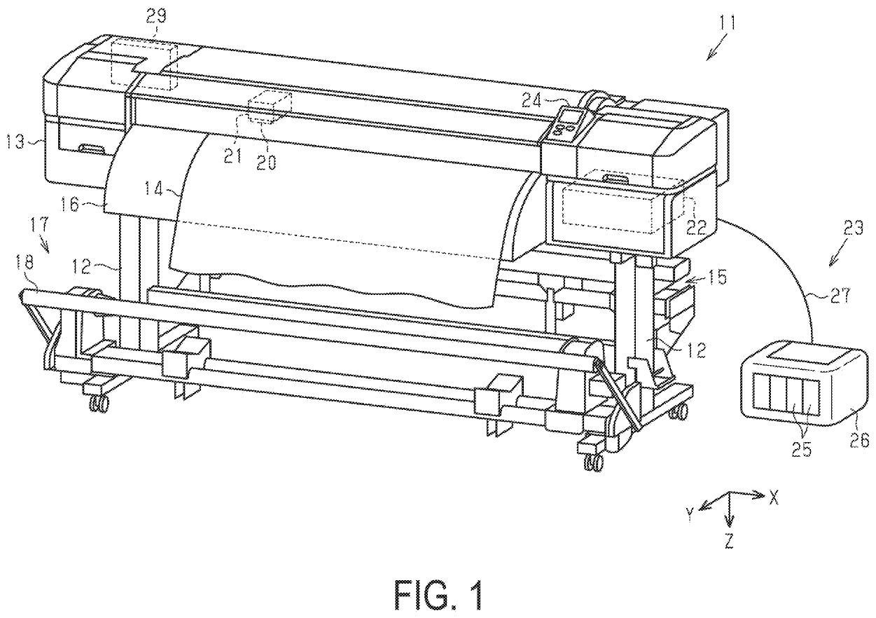

As illustrated in FIG. 1, the liquid ejecting device 11 may include a pair of legs 12 and a housing 13 assembled above the legs 12. The liquid ejecting device 11 may include a feeding portion 15 that unwinds and feeds a medium 14 wound in a roll shape, a guide unit 16 that guides the medium 14 ejected from the housing 13, and a collection unit 17 that winds and collects the medium 14. The liquid ejecting device 11 may include a tension applying mechanism 18 that applies tension to the medium 14 being collected by the collection unit 17.

The liquid ejecting device 11 includes a recording unit 20 that ejects liquid to perform recording. The liquid ejecting device 11 may include a carriage 21 that moves the recording unit 20. The liquid ejecting device 11 includes a cleaning unit 22 that cleans the recording unit 20. The liquid ejecting device 11 may include a liquid supply device 23 that supplies liquid to the recording unit 20, and an operating panel 24 operated by a user.

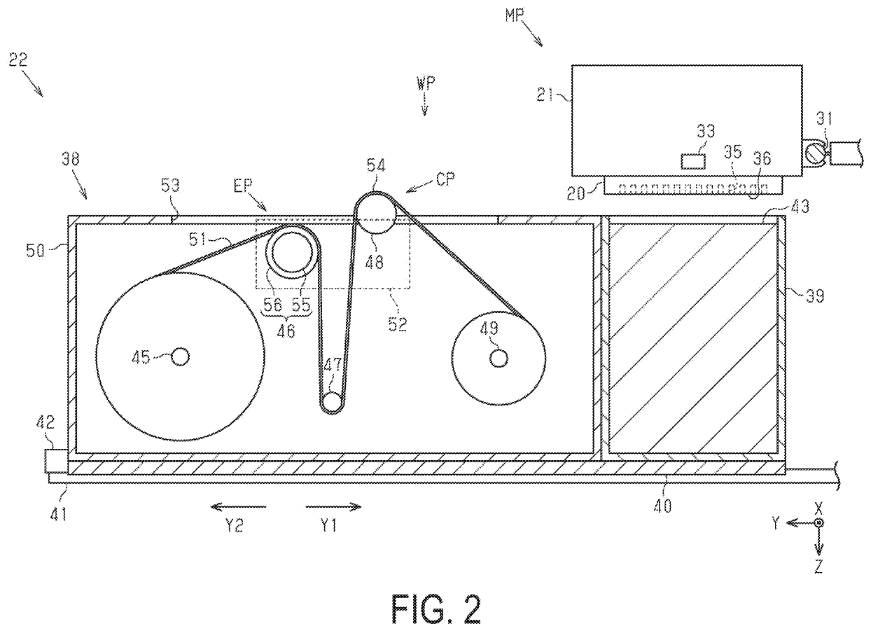

The carriage 21 reciprocates the recording unit 20 along the X-axis. The recording unit 20 is capable of moving to a recording region for recording on the medium 14, and to a maintenance position MP illustrated in FIG. 2. The recording unit 20 ejects the liquid supplied through the liquid supply device 23 while moving, and records on the medium 14.

The liquid supply device 23 may include a mounting portion 26 in which a plurality of liquid accommodating bodies 25 for accommodating liquid are detachably mounted, and a supply flow path 27 that supplies liquid to the recording unit 20 from the liquid accommodating body 25 mounted to the mounting portion 26.

The liquid ejecting device 11 includes a control unit 29. The control unit 29 generally controls driving of each mechanism in the liquid ejecting device 11, and controls various types of operation performed in the liquid ejecting device 11. The control unit 29 may be configured as a circuit including, α: one or more processors that perform various types of processing in accordance with a computer program, β: one or more dedicated hardware circuits such as application specific integrated circuits that perform at least a part of processing of the various types of processing, or γ: a combination thereof. The processor includes a CPU, and memories such as a RAM and a ROM, and the memory stores a program code or a command configured to cause the CPU to execute processing. The memory, or a computer readable medium includes any readable medium accessible by a general purpose or special purpose computer.

As illustrated in FIG. 2, the liquid ejecting device 11 may include a guide shaft 31 that guides the carriage 21. The carriage 21, along with driving of a carriage motor (not illustrated), reciprocates along the guide shaft 31.

The liquid ejecting device 11 includes a temperature detection unit 33 that detects temperature. The temperature detection unit 33 of the present exemplary embodiment is provided at the carriage 21. The temperature detection unit 33 moves along with the carriage 21 and the recording unit 20, and detects a temperature around the recording unit 20.

The recording unit 20 has a nozzle surface 36 provided with a nozzle 35. The recording unit 20 ejects liquid from the nozzle 35 in a ejecting direction Z onto the medium 14 to perform recording. The ejecting direction Z of the present exemplary embodiment is parallel to the Z-axis, and coincides with a vertical direction. Accordingly, the recording unit 20 of the present exemplary embodiment ejects liquid downward.

Cleaning Unit

As illustrated in FIG. 2, the cleaning unit 22 is aligned in the ejecting direction Z with the recording unit 20 located at the maintenance position MP, and faces the nozzle surface 36. Specifically, the cleaning unit 22 of the present exemplary embodiment is located below a movement region in which the recording unit 20 moves.

The cleaning unit 22 includes a wiping mechanism 38 capable of wiping off the nozzle surface 36. The cleaning unit 22 may include a liquid receiving portion 39 that receives liquid ejected from the nozzle 35 in association with flushing, and a holding unit 40 that holds the wiping mechanism 38 and the liquid receiving portion 39. The liquid ejecting device 11 may include a rail 41 that guides movement of the cleaning unit 22, and a detection unit 42 capable of detecting a position of the moving cleaning unit 22. The detection unit 42 may be, for example, a sensor that detects the cleaning unit 22, or a linear encoder capable of measuring a movement distance of the cleaning unit 22.

The cleaning unit 22 moves along the rail 41 in a cleaning direction Y1, or a return direction Y2 opposite to the cleaning direction Y1. The cleaning direction Y1 and the return direction Y2 of the present exemplary embodiment are directions parallel to the Y-axis. The wiping mechanism 38 and the liquid receiving portion 39 of the present exemplary embodiment are held by the holding unit 40 in a state of being aligned in the cleaning direction Y1. Specifically, the wiping mechanism 38 is provided adjacent to the liquid receiving portion 39 at a position upstream the liquid receiving portion 39 in the cleaning direction Y1.

Liquid Accommodating Portion

As illustrated in FIG. 2, the liquid receiving portion 39 located at a waiting position WP is aligned with the recording unit 20 located at the maintenance position MP in the ejecting direction Z. The liquid receiving portion 39 accommodates liquid ejected from the nozzle 35 as a waste liquid. The liquid receiving portion 39 may include an intake portion 43 that takes in liquid. The intake portion 43 may be formed of an absorbent body capable of absorbing liquid.

Wiping Mechanism

The wiping mechanism 38 may include a feeding shaft 45, a second pressing unit 46, which is an example of a pressing unit, a tension roller 47, a first pressing unit 48, which is an example of the pressing unit, a winding shaft 49, and a frame body 50 that rotatably supports these. The wiping mechanism 38 may include an absorbent member 51 capable of contacting the nozzle surface 36 and absorbing liquid.

The first pressing unit 48 is located between the second pressing unit 46 and the liquid receiving portion 39 in the cleaning direction Y1. In other words, in the cleaning direction Y1, a distance between the first pressing unit 48 and the liquid receiving portion 39 is shorter than a distance between the second pressing unit 46 and the liquid receiving portion 39.

The feeding shaft 45 holds the band-like absorbent member 51 in a state of being wound in a roll shape. The absorbent member 51 fed from the feeding shaft 45 is transported along a transport path. The absorbent member 51 is wound around the second pressing unit 46, the tension roller 47, and the first pressing unit 48, which are provided in order from upstream the transport path. The winding shaft 49 is rotated by driving of a winding motor (not illustrated). The winding shaft 49 winds the absorbent member 51 in a roll shape. The winding motor may rotate at least one of the feeding shaft 45, the second pressing unit 46, the tension roller 47, and the first pressing unit 48, together with the winding shaft 49.

The feeding shaft 45, the second pressing unit 46, the tension roller 47, the first pressing unit 48, and the winding shaft 49 are provided, with the X-axis as an axial direction, and support the absorbent member 51. In the present exemplary embodiment, a direction along a width of the absorbent member 51 is referred to as a width direction X. The width direction X is parallel to the X-axis.

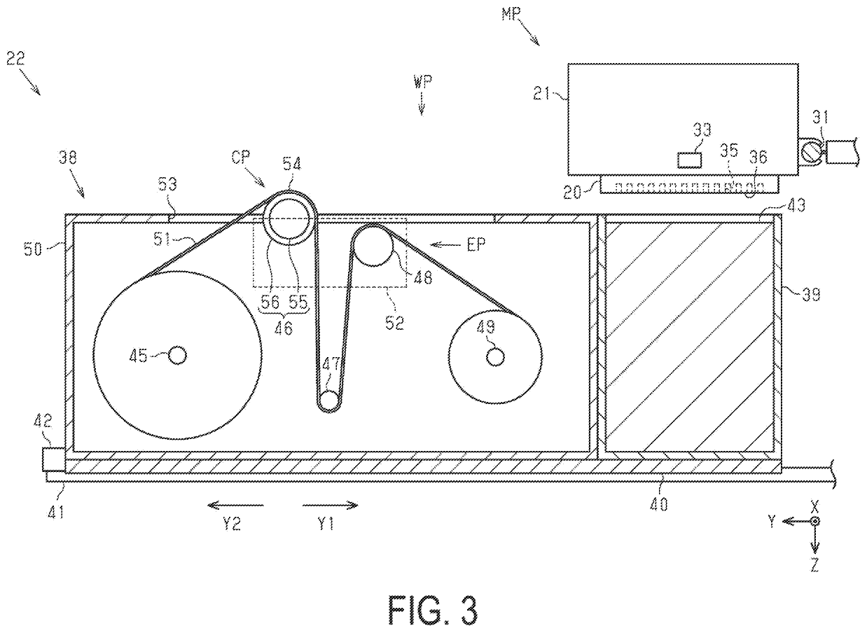

As illustrated in FIG. 2 and FIG. 3, the wiping mechanism 38 may include a movement mechanism 52 that moves the first pressing unit 48 and the second pressing unit 46. The movement mechanism 52 may move the first pressing unit 48 and the second pressing unit 46 individually, or in conjunction with each other. For example, each of the first pressing unit 48 and the second pressing unit 46 is configured to be movable to a cleaning position CP where the nozzle surface 36 can be cleaned, and to an retracted position EP retracted from the cleaning position CP.

The movement mechanism 52 locates one of the first pressing unit 48 and the second pressing unit 46 at the cleaning position CP, while locating another at the retracted position EP. Specifically, as illustrated in FIG. 2, the movement mechanism 52 locates the first pressing unit 48 at the cleaning position CP, and locates the second pressing unit 46 at the retracted position EP. As illustrated in FIG. 3, the movement mechanism 52 locates the second pressing unit 46 at the cleaning position CP, and locates the first pressing unit 48 at the retracted position EP.

One of the first pressing unit 48 and the second pressing unit 46, which is located at the cleaning position CP, presses the absorbent member 51 up from below, and protrudes the absorbent member 51 from an opening 53 formed in the frame body 50. A part of the absorbent member 51, which is pressed up by the first pressing unit 48 or the second pressing unit 46 located at the cleaning position CP, serves as a wiping part 54 capable of wiping off the nozzle surface 36. The retracted position EP is a position moved from the cleaning position CP in the ejecting direction Z, and is a position where the absorbent member 51 does not contact the nozzle surface 36.

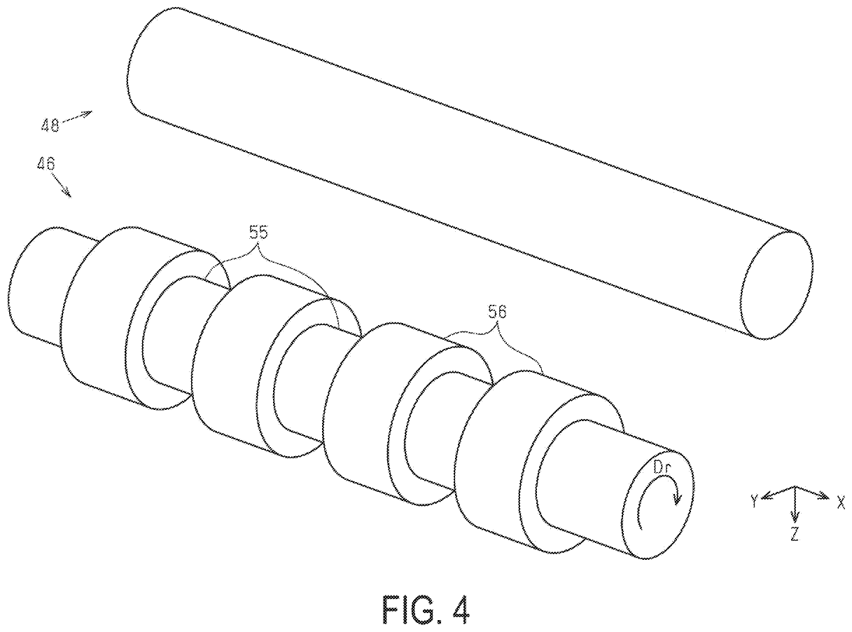

As illustrated in FIG. 4, the first pressing unit 48 may be formed in a cylindrical shape. The second pressing unit 46 may include a base portion 55, and a convex portion 56 that protrudes with respect to the base portion 55. A diameter of the first pressing unit 48 is the same as a diameter of the base portion 55 of the second pressing unit 46. The second pressing unit 46 may include the plurality of convex portions 56 provided at intervals in the width direction X. The second pressing unit 46 of the present exemplary embodiment includes the four convex portions 56. A portion between the convex portions 56 in the width direction X is the base portion 55. In the second pressing unit 46, the cylindrical base portions 55 and the cylindrical convex portion 56 are alternately aligned in the width direction X.

The convex portion 56 protrudes radially from the base portion 55 along an entire circumference of the base portion 55 in a rotational direction Dr, with the base portion 55 as an axis. A diameter of the convex portion 56 is greater than a diameter of the base portion 55. The convex portion 56 may be formed integrally with the base portion 55, or may be mounted to the base portion 55.

Recording Unit

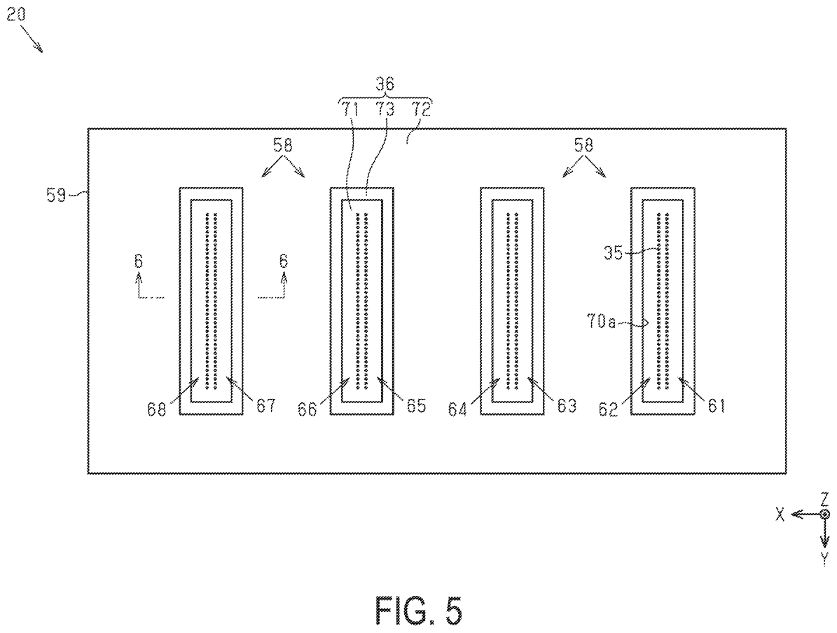

As illustrated in FIG. 5, the recording unit 20 may include a liquid ejecting head 58, and a support portion 59 that supports the liquid ejecting head 58. The recording unit 20 may include the plurality of liquid ejecting heads 58. The recording unit 20 according to the present exemplary embodiment includes the four liquid ejecting heads 58 aligned at intervals along the X-axis. In other words, the recording unit 20 includes the same number of liquid ejecting heads 58 as the convex portions 56 included in the second pressing unit 46. Since the configuration of each of the liquid ejecting heads 58 is the same, one liquid ejecting head 58 will be described below.

In the liquid ejecting head 58, a large number of openings of the nozzles 35 are aligned at a constant interval in one direction. The plurality of nozzles 35 aligned in a row constitute a nozzle row. The recording unit 20 of the present exemplary embodiment includes a first nozzle row 61 to an eighth nozzle row 68 provided at intervals in the width direction X.

Pairs in the first nozzle row 61 to the eighth nozzle row 68 of the present exemplary embodiment are provided in the liquid ejecting heads 58, respectively. In other words, the first nozzle row 61 and the second nozzle row 62 are provided in the same liquid ejecting head 58, and the third nozzle row 63 and the fourth nozzle row 64 are provided in the same liquid ejecting head 58. Similarly, the fifth nozzle row 65 and the sixth nozzle row 66 are provided in the same liquid ejecting head 58, and the seventh nozzle row 67 and the eighth nozzle row 68 are provided in the same liquid ejecting head 58. The recording unit 20 may eject a different type of liquid from each nozzle row, or may eject a different type of liquid from each liquid ejecting head 58.

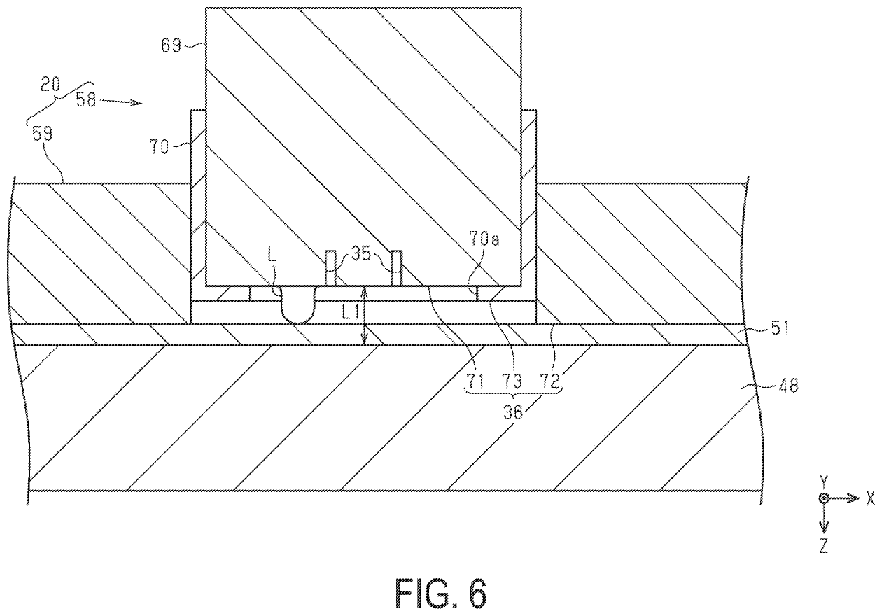

As illustrated in FIG. 6, the liquid ejecting head 58 may include a nozzle forming member 69 formed with the nozzle 35, and a fixing portion 70 that fixes the nozzle forming member 69 to the support portion 59. A part of the nozzle forming member 69 is exposed from a hole 70a formed in the fixing portion 70.

The nozzle surface 36 may include a first surface 71 in which the nozzle 35 is open, a second surface 72 included in the support portion 59, and a third surface 73 included in the fixing portion 70. The first surface 71 is a part of a lower surface of the nozzle forming member 69 that is exposed from the hole 70a. The second surface 72 is located between the first surface 71, and the first pressing unit 48 and the second pressing unit 46 in the ejecting direction Z. The second surface 72 of the present exemplary embodiment is located below the first surface 71. The third surface 73 is located between the first surface 71 and the second surface 72 in the ejecting direction Z. The first surface 71 and the third surface 73 are surfaces recessed with respect to the second surface 72. The first surface 71 is a surface recessed with respect to the third surface 73.

Next, actions of the present exemplary embodiment will be described.

When Detected Temperature is Equal to or Greater than Predetermined Temperature

As illustrated in FIG. 2, when a detected temperature detected by the temperature detection unit 33 is equal to or greater than a predetermined temperature, the first pressing unit 48 cleans the nozzle surface 36. In other words, the cleaning unit 22 locates the first pressing unit 48 at the cleaning position CP and locates the second pressing unit 46 at the retracted position EP to clean the nozzle surface 36.

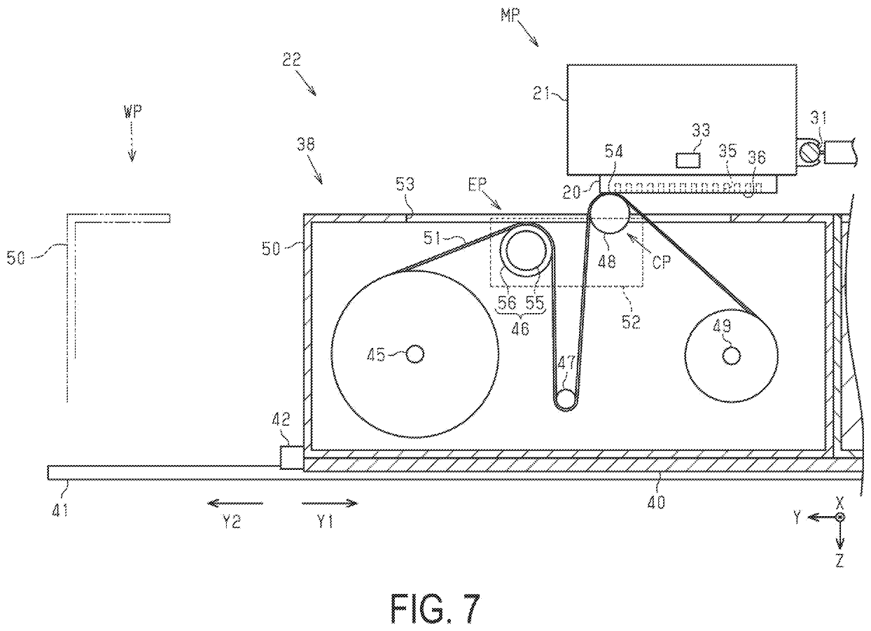

As illustrated in FIG. 7, the cleaning unit 22 moves from the waiting position WP in the cleaning direction Y1 to clean the nozzle surface 36. In other words, the cleaning unit 22 moves the first pressing unit 48, the second pressing unit 46, and the liquid receiving portion 39 in the cleaning direction Y1 to clean the nozzle surface 36. The cleaning direction Y1 is a direction in which, when cleaning the nozzle surface 36, the wiping mechanism 38 moves.

The absorbent member 51 wipes off a foreign material such as liquid adhering to the nozzle surface 36, with the wiping part 54 in contact with the nozzle surface 36. In other words, the first pressing unit 48 presses the absorbent member 51 against the nozzle surface 36 to clean the nozzle surface 36. Thus, the cleaning unit 22 performs cleaning with the absorbent member 51 sandwiched between the first pressing unit 48 and the nozzle surface 36.

As illustrated in FIG. 6, the first pressing unit 48 sets a distance in the ejecting direction Z from the first surface 71 to the first pressing unit 48 to a first distance L1 to perform cleaning. When temperature is high, fluidity of liquid is higher than when temperature is low. Therefore, even when there is a gap between the absorbent member 51 and the first surface 71, liquid L adhering to the first surface 71 contacts the absorbent member 51, or moves to the absorbent member 51 along the fixing portion 70 and a side wall of the support portion 59, and is absorbed in the absorbent member 51.

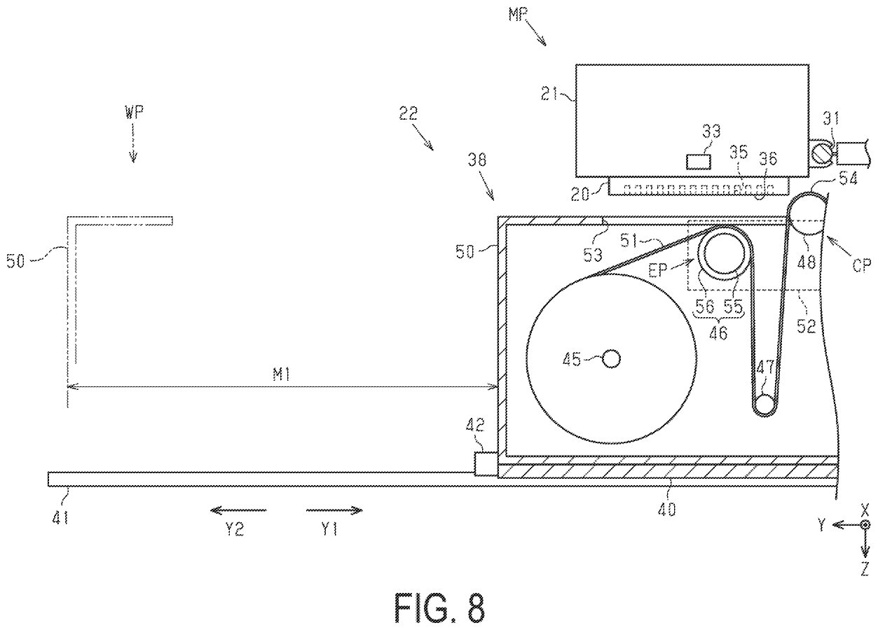

As illustrated in FIG. 8, when the first pressing unit 48 passes through the nozzle surface 36, the control unit 29 stops moving the cleaning unit 22, and moves the recording unit 20 from the maintenance position MP. Specifically, the control unit 29, after moving the cleaning unit 22 from the waiting position WP in the cleaning direction Y1 by a first movement distance M1, moves the cleaning unit 22 in the return direction Y2 by the first movement distance M1, and then returns the cleaning unit 22 to the waiting position WP. The control unit 29 moves the cleaning unit 22 in the return direction Y2 with the recording unit 20 separated from the maintenance position MP.

As illustrated in FIG. 2, the control unit 29 returns the cleaning unit 22 to the waiting position WP, and returns the recording unit 20 to the maintenance position MP to perform flushing. The recording unit 20 located at the maintenance position MP faces the liquid receiving portion 39 located at the waiting position WP. Therefore, the liquid receiving portion 39 accommodates liquid discharged in association with the flushing.

When Detected Temperature is Less than Predetermined Temperature

As illustrated in FIG. 3, when the detected temperature detected by the temperature detection unit 33 is less than the predetermined temperature, the second pressing unit 46 cleans the nozzle surface 36. In other words, the cleaning unit 22 locates the first pressing unit 48 at the retracted position EP and locates the second pressing unit 46 at the cleaning position CP to clean the nozzle surface 36.

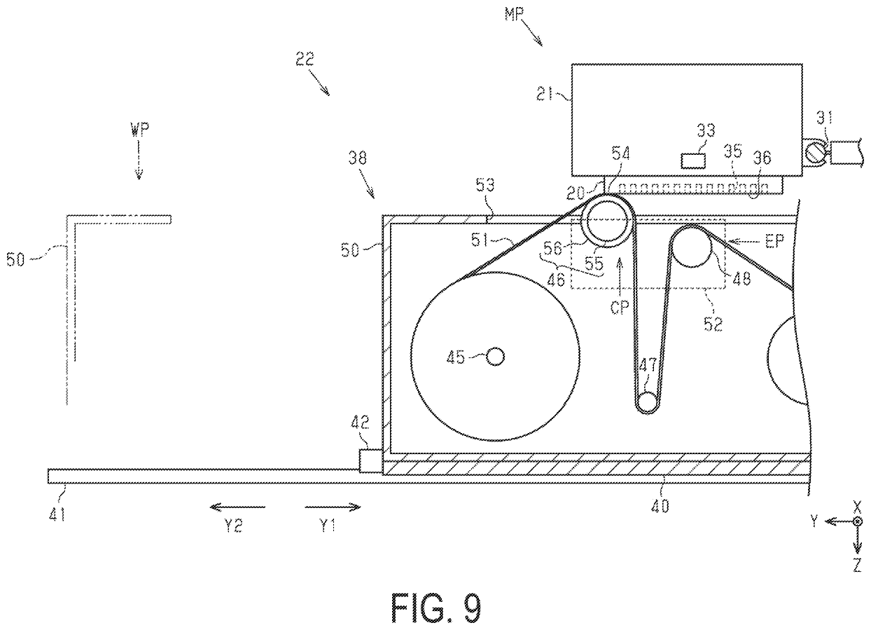

As illustrated in FIG. 9, the cleaning unit 22 moves from the waiting position WP in the cleaning direction Y1 to clean the nozzle surface 36. The wiping part 54 contacts the nozzle surface 36 when the wiping mechanism 38 moves in the cleaning direction Y1, and wipes off a foreign material such as liquid adhering to the nozzle surface 36. In other words, the second pressing unit 46 presses the absorbent member 51 against the nozzle surface 36 to clean the nozzle surface 36. Thus, the cleaning unit 22 performs cleaning with the absorbent member 51 sandwiched between the second pressing unit 46 and the nozzle surface 36.

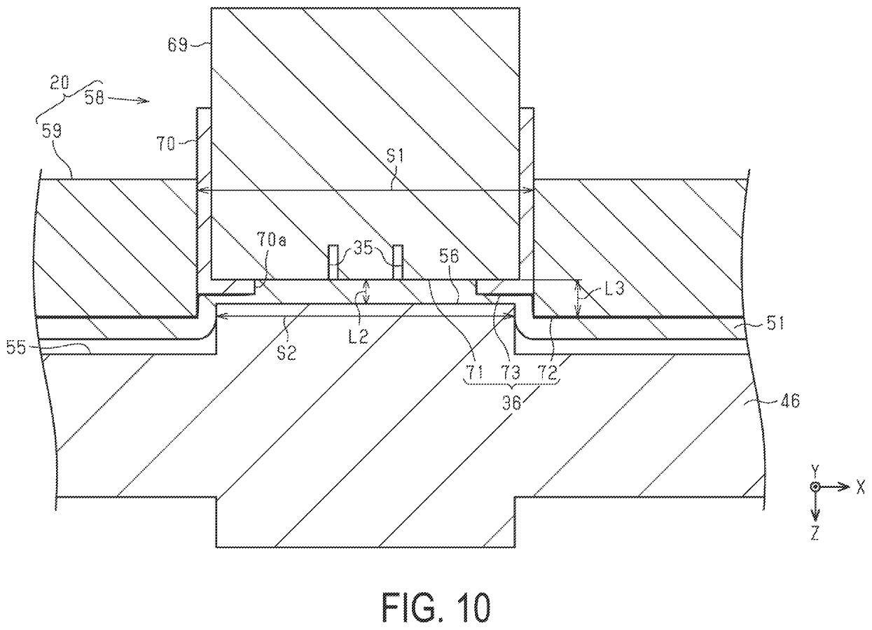

As illustrated in FIG. 10, when the detected temperature is lower than the predetermined temperature, the cleaning unit 22 locates the convex portion 56 at a position that is between the first surface 71 and the base portion 55 in the ejecting direction Z, and that is a position aligned with the first surface 71 in the ejecting direction Z.

In the width direction X, a first dimension S1 of the liquid ejecting head 58 is greater than a second dimension S2 of the convex portion 56. The second pressing unit 46 sets a distance in the ejecting direction Z from the first surface 71 to the second pressing unit 46 to a second distance L2 that is shorter than the first distance L1 to perform cleaning. The second distance L2 is shorter than a third distance L3 from the first surface 71 to the second surface 72 in the ejecting direction Z.

When temperature is low, fluidity of liquid is lower than when temperature is high. The second pressing unit 46 presses the absorbent member 51 into the first surface 71 recessed with respect to the support portion 59 to clean the first surface 71 and the second surface 72.

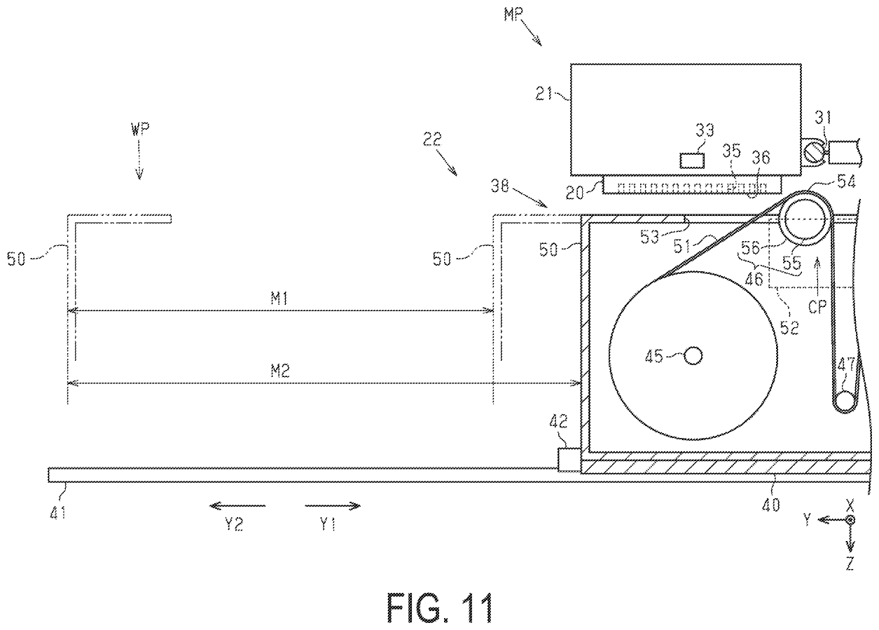

As illustrated in FIG. 11, when the second pressing unit 46 passes through the nozzle surface 36, the control unit 29 stops moving the cleaning unit 22, and moves the recording unit 20 from the maintenance position MP. Specifically, the control unit 29, after moving the cleaning unit 22 from the waiting position WP in the cleaning direction Y1 by a second movement distance M2, which is longer than the first movement distance M1, moves the cleaning unit 22 in the return direction Y2 by the second movement distance M2, and then returns the cleaning unit 22 to the waiting position WP. The control unit 29 moves the cleaning unit 22 in the return direction Y2 with the recording unit 20 separated from the maintenance position

MP.

As illustrated in FIG. 3, the control unit 29 returns the cleaning unit 22 to the waiting position WP, and returns the recording unit 20 to the maintenance position MP to perform flushing. The liquid receiving portion 39 accommodates liquid discharged in association with the flushing.

Effects of the present exemplary embodiment will now be described.

(1) The nozzle surface 36 includes the first surface 71 and the second surface 72. The second surface 72 is located between the first surface 71, and the first pressing unit 48 and the second pressing unit 46 in the ejecting direction Z. The first surface 71 located at a position separated from the first pressing unit 48 and the second pressing unit 46 is less likely to be cleaned by the first pressing unit 48 and the second pressing unit 46 compared to the second surface 72. The ease of cleaning is also affected by temperature. Specifically, when temperature is low, viscosity of the liquid L adhering to the nozzle surface 36 increases compared to when temperature is high, thus cleaning is difficult. In that regard, the cleaning unit 22, when a detected temperature is lower than a predetermined temperature, sets a distance from the first surface 71 to the first pressing unit 48 and the second pressing unit 46 to be shorter than when the detected temperature is equal to or greater than the predetermined temperature. In other words, when the detected temperature is low and the viscosity of the liquid is high, the second pressing unit 46 approaches the first surface 71 to clean the first surface 71. Thus, cleaning can be performed well even when temperature changes.

(2) When the detected temperature is less than the predetermined temperature, the convex portion 56 included in the second pressing unit 46, and the first surface 71 included in the nozzle surface 36 are aligned in the ejecting direction Z. At this time, the convex portion 56 is located at a position between the first surface 71 and the base portion 55 in the ejecting direction Z. Thus, in the ejecting direction Z, a distance from the first surface 71 to the convex portion 56 is shorter than a distance from the first surface 71 to the base portion 55. Accordingly, a distance between the first surface 71 and the second pressing unit 46 can be easily shortened.

(3) The cleaning unit 22 includes the first pressing unit 48 and the second pressing unit 46. The cleaning unit 22 can selectively use the first pressing unit 48 and the second pressing unit 46 in accordance with a detected temperature to perform cleaning well.

(4) Along with cleaning of the nozzle surface 36, the cleaning unit 22 may press liquid adhering to the nozzle surface 36 into the nozzle 35. The liquid pressed into the nozzle 35 may evaporate over time and clog the nozzle 35. When temperature is high, liquid is more likely to evaporate than when temperature is low. Therefore, when temperature is high, flushing may be performed quickly after cleaning is performed. In that regard, in the cleaning direction Y1, an interval between the first pressing unit 48 that performs cleaning when a detected temperature is equal to or greater than a predetermined temperature and the liquid receiving portion 39 is set to be less than an interval between the second pressing unit 46 that performs cleaning when the detected temperature is lower than the predetermined temperature and the liquid receiving portion 39. In other words, by providing the first pressing unit 48 at a position close to the liquid receiving portion 39, the liquid receiving portion 39 can be caused to quickly face the nozzle surface 36 after the nozzle surface 36 is cleaned by the first pressing unit 48, and the recording unit 20 can be caused to perform flushing.

(5) When the first pressing unit 48 is located at the cleaning position CP, the second pressing unit 46 is located at the retracted position EP. When the first pressing unit 48 is located at the retracted position EP, the second pressing unit 46 is located at the cleaning position CP. As a result, one of the first pressing unit 48 and the second pressing unit 46, which is located at the cleaning position CP, can be used to perform cleaning. Thus, a load on the nozzle surface 36 can be reduced compared to when both the first pressing unit 48 and the second pressing unit 46 are located at the cleaning position CP to perform cleaning.

(6) The absorbent member 51 is capable of absorbing liquid. Thus, by performing cleaning while the cleaning unit 22 and the recording unit 20 sandwich the absorbent member 51, liquid adhering to the nozzle surface 36 can be absorbed, and liquid remaining on the nozzle surface 36 can be reduced.

### Exemplary Embodiment 2

Next, Exemplary Embodiment 2 of the liquid ejecting device will be described with reference to the drawings. Note that, this Exemplary Embodiment 2 is different from Exemplary Embodiment 1 in a wiping mechanism. Further, since other points are substantially the same as those of the first embodiment, duplicate descriptions of the same configuration will be omitted while assigning the same reference signs to the same components.

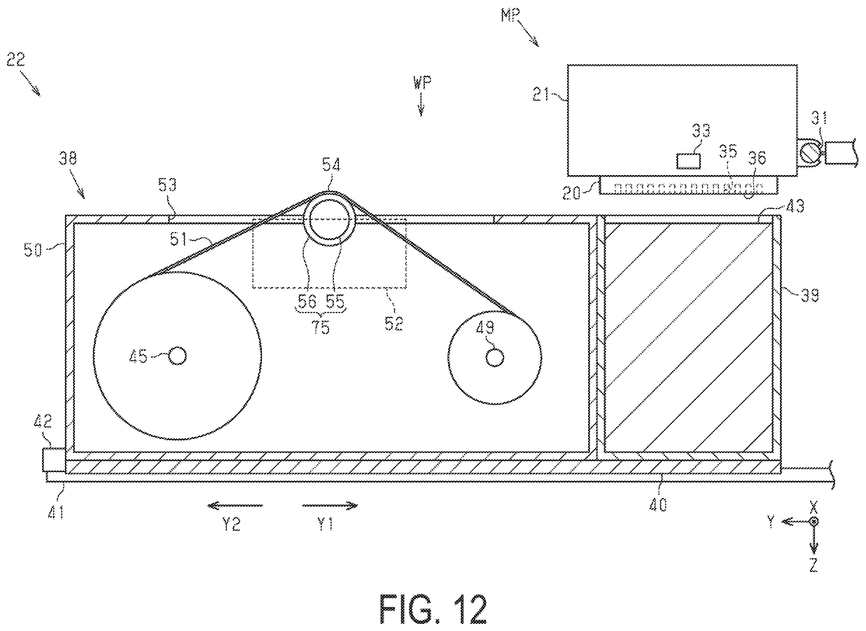

As illustrated in FIG. 12, the wiping mechanism 38 may include the feeding shaft 45, a pressing unit 75, and the winding shaft 49. A configuration of the pressing unit 75 of Exemplary Embodiment 2 is the same as the configuration of the second pressing unit 46 of Exemplary Embodiment 1. In other words, the pressing unit 75 of the present exemplary embodiment includes the base portion 55, and the convex portion 56 that protrudes with respect to the base portion 55. The base portion 55 and the convex portion 56 are aligned in the width direction X.

The pressing unit 75 presses the absorbent member 51 up from below, and protrudes the absorbent member 51 from the opening 53. A part of the absorbent member 51 that is pressed up by the pressing unit 75 serves as the wiping part 54 capable of contacting the nozzle surface 36. The movement mechanism 52 reciprocates the pressing unit 75 along the X-axis. In other words, the pressing unit 75 is provided so as to be movable in the width direction X.

Next, actions of the present exemplary embodiment will be described.

When Detected Temperature is Equal to or Greater than Predetermined Temperature

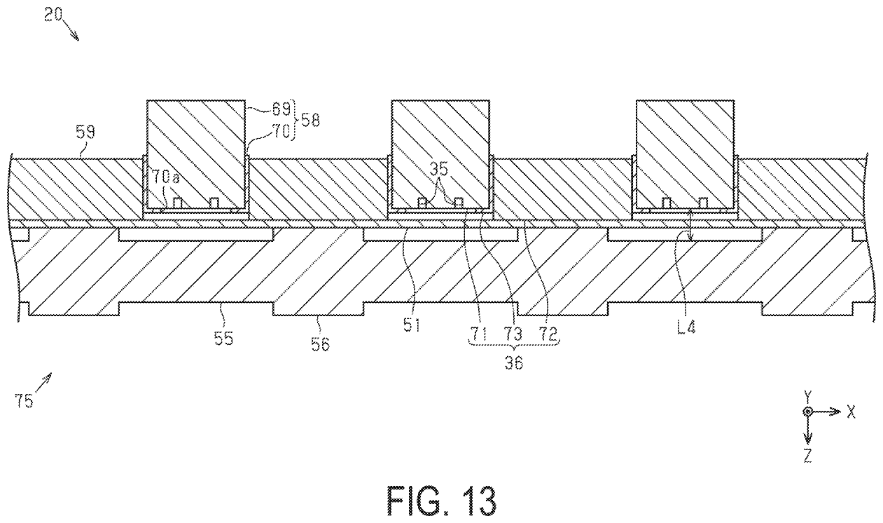

As illustrated in FIG. 13, when a detected temperature detected by the temperature detection unit 33 is equal to or greater than a predetermined temperature, the cleaning unit 22 locates the base portion 55 at a position aligned with the first surface 71 in the ejecting direction Z. The pressing unit 75 sets a distance in the ejecting direction Z from the first surface 71 to the pressing unit 75 to a high temperature distance L4, which is an example of a first distance, to perform cleaning.

The cleaning unit 22 moves from the waiting position WP in the cleaning direction Y1 to clean the nozzle surface 36. At this time, the cleaning unit 22 may relatively move the pressing unit 75 and the recording unit 20 at a first speed to perform cleaning. A first movement speed is a speed slower than a second speed when the pressing unit 75 and the recording unit 20 are relatively moved, when the detected temperature is lower than the predetermined temperature.

The pressing unit 75 presses the absorbent member 51 against the nozzle surface 36 to clean the nozzle surface 36. The cleaning unit 22 performs cleaning with the absorbent member 51 sandwiched between the pressing unit 75 and the nozzle surface 36.

When Detected Temperature is Less than Predetermined Temperature

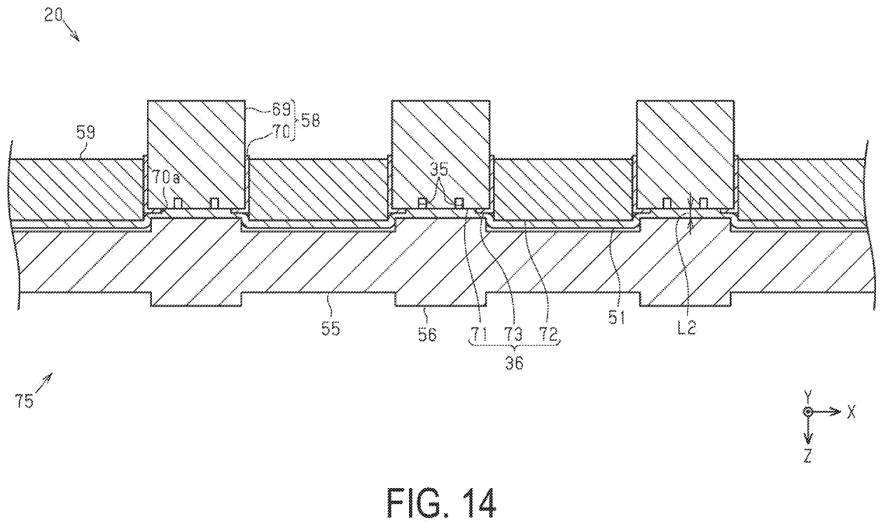

As illustrated in FIG. 14, when the detected temperature detected by the temperature detection unit 33 is lower than the predetermined temperature, the cleaning unit 22 locates the convex portion 56 at a position that is between the first surface 71 and the base portion 55 in the ejecting direction Z, and that is a position aligned with the first surface 71 in the ejecting direction Z. The pressing unit 75 sets a distance in the ejecting direction Z from the first surface 71 to the pressing unit 75 to the second distance L2 that is shorter than the high temperature distance L4 to perform cleaning.

The cleaning unit 22 moves from the waiting position WP in the cleaning direction Y1 to clean the nozzle surface 36. At this time, the cleaning unit 22 may relatively move the pressing unit 75 and the recording unit 20 at a second speed that is faster than the first speed to perform cleaning.

Effects of the present exemplary embodiment will now be described.

(7) When a detected temperature is equal to or greater than a predetermined temperature, the base portion 55 included in the pressing unit 75, and the first surface 71 included in the nozzle surface 36 are aligned in the ejecting direction Z. In other words, depending on whether the base portion 55 or the convex portion 56 is located at a position aligned with the first surface 71 in the ejecting direction Z, the pressing unit 75 can change a distance from the first surface 71 in the ejecting direction Z. Thus, a distance between the first surface 71 and the cleaning unit 22 can be changed by one pressing unit 75.

(8) The pressing unit 75 is provided so as to be movable in the width direction X in which the base portion 55 and the convex portion 56 are aligned. For example, by moving the pressing unit 75 in the width direction X with the first surface 71 and the convex portion 56 aligned in the ejecting direction Z, the convex portion 56 can be moved from a position aligned with the first surface 71, and the base portion 55 can be moved to a position aligned with the first surface 71. Accordingly, a distance between the first surface 71 and the pressing unit 75 can be easily changed.

(9) Liquid is more likely to flow when temperature is high, compared to when temperature is low. When a detected temperature is equal to or greater than a predetermined temperature, the cleaning unit 22 moves the pressing unit 75 and the recording unit 20 relatively at a first speed that is slower than a second speed to perform cleaning. Thus, even in a case of cleaning performed while a distance between the first surface 71 and the pressing unit 75 is set to the high temperature distance L4 that is longer than the second distance L2, the cleaning can be performed while waiting for the liquid L adhering to the first surface 71 to move.

### Exemplary Embodiment 3

Next, Exemplary Embodiment 3 of the liquid ejecting device will be described with reference to the drawings. Note that, this Exemplary Embodiment 3 is different from Exemplary Embodiment 1 in respective shapes of a recording unit and a pressing unit. Further, since other points are substantially the same as those of the first embodiment, duplicate descriptions of the same configuration will be omitted while assigning the same reference signs to the same components.

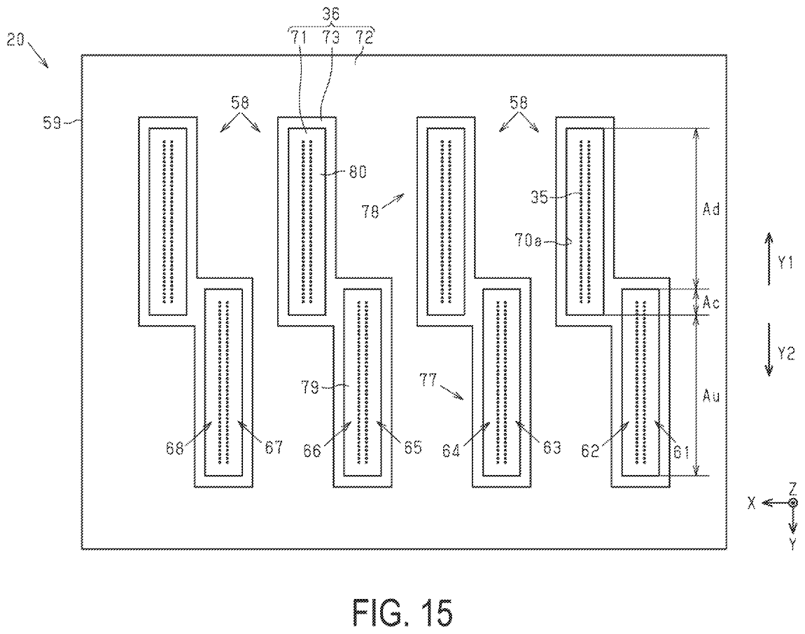

As illustrated in FIG. 15, each nozzle row of the first nozzle row 61 to the eighth nozzle row 68 may have a first nozzle group 77 and a second nozzle group 78. The first nozzle group 77 and the second nozzle group 78 are located shifted from each other, in the width direction X and the cleaning direction Y1, and partially overlap in the cleaning direction Y1. The first nozzle group 77 and the second nozzle group 78 are each constituted by the plurality of nozzles 35 aligned in the cleaning direction Y1.

The recording unit 20 includes the plurality of first surfaces 71. Specifically, one liquid ejecting head 58 includes the first surface 71 in which the nozzles 35 constituting the first nozzle group 77 open, and the first surface 71 in which the nozzles 35 constituting the second nozzle group 78 open. In the following description, the first surface 71 corresponding to the first nozzle group 77 is also referred to as an upstream surface 79 located upstream in the cleaning direction Y1, and the first surface 71 corresponding to the second nozzle group 78 is also referred to as a downstream surface 80 located downstream in the cleaning direction Y1. The upstream surface 79 and the downstream surface 80 are provided shifted from each other, in the width direction X and the cleaning direction Y1.

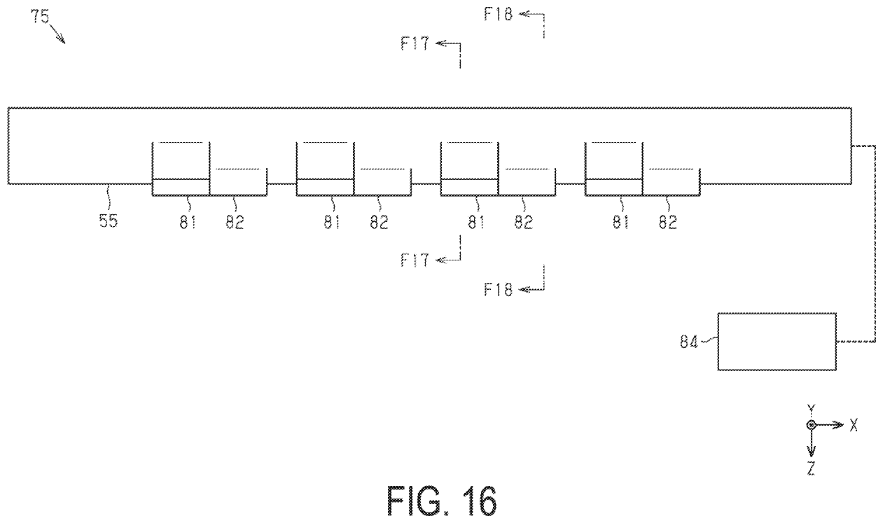

As illustrated in FIG. 16, the pressing unit 75 includes the base portion 55 formed in a cylindrical shape, a first convex portion 81, which is an example of a convex portion protruding with respect to the base portion 55, and a second convex portion 82, which is an example of the convex portion. In other words, the pressing unit 75 includes the plurality of convex portions. The first convex portion 81 and the second convex portion 82 are provided shifted from each other, in the width direction X. The pressing unit 75 has the same number of first convex portions 81 and second convex portions 82 as the liquid ejecting heads 58.

The first convex portion 81 is located at the same position in the width direction X as the upstream surface 79 located at the maintenance position MP. The second convex portion 82 is located at the same position in the width direction X as the downstream surface 80 located at the maintenance position MP.

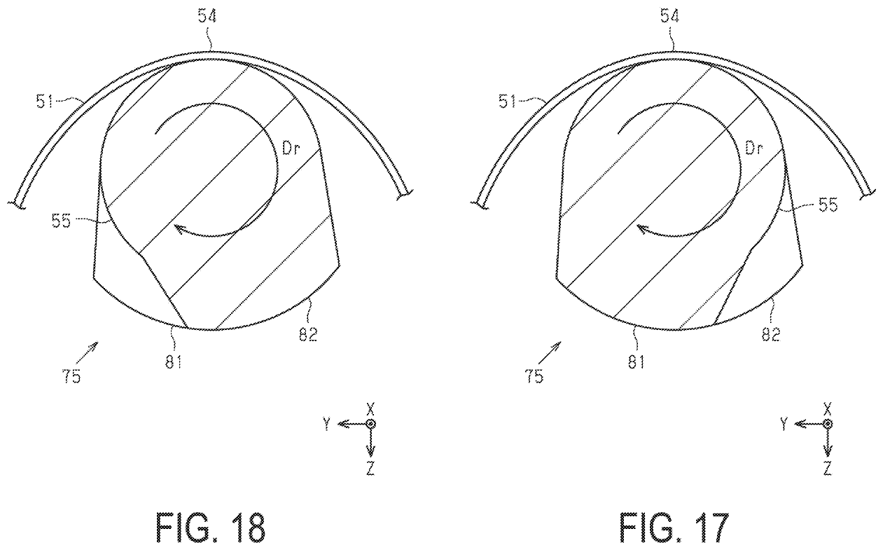

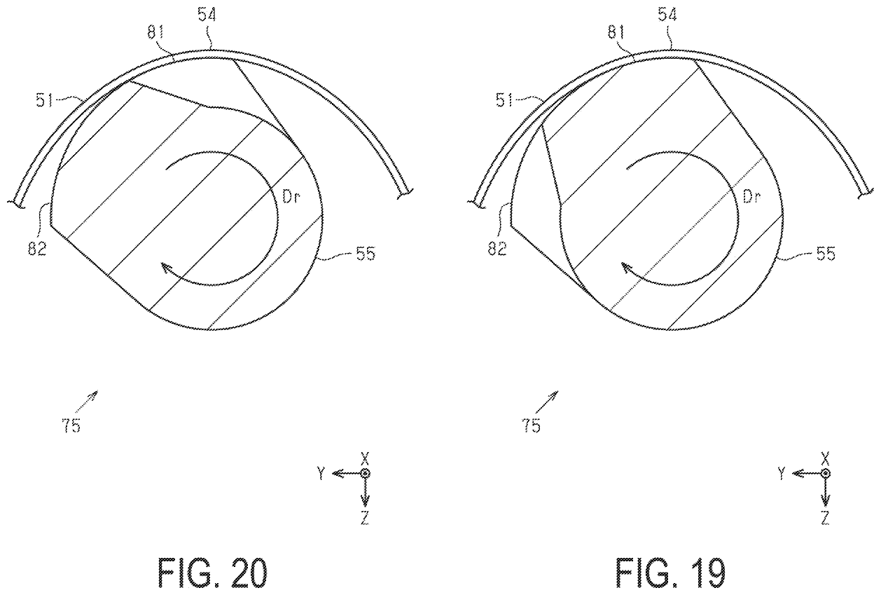

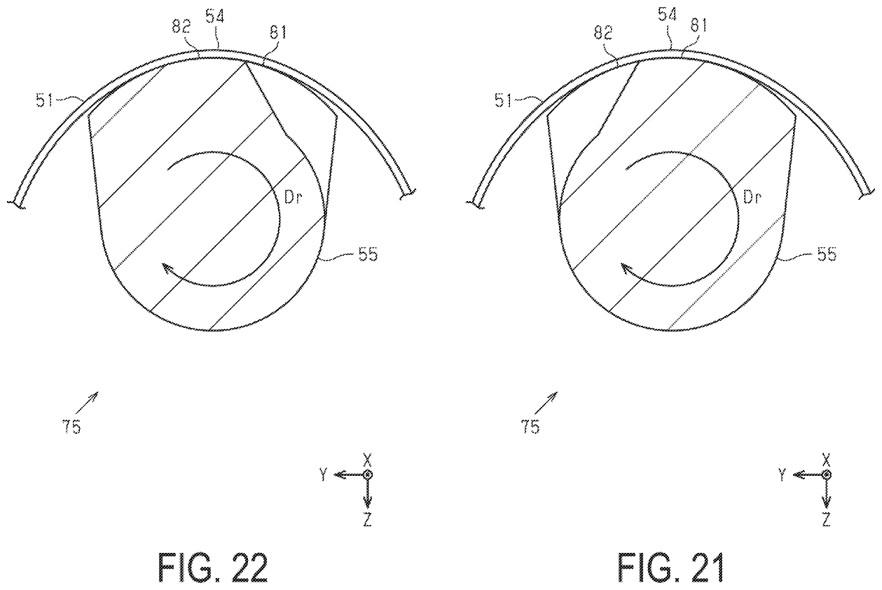

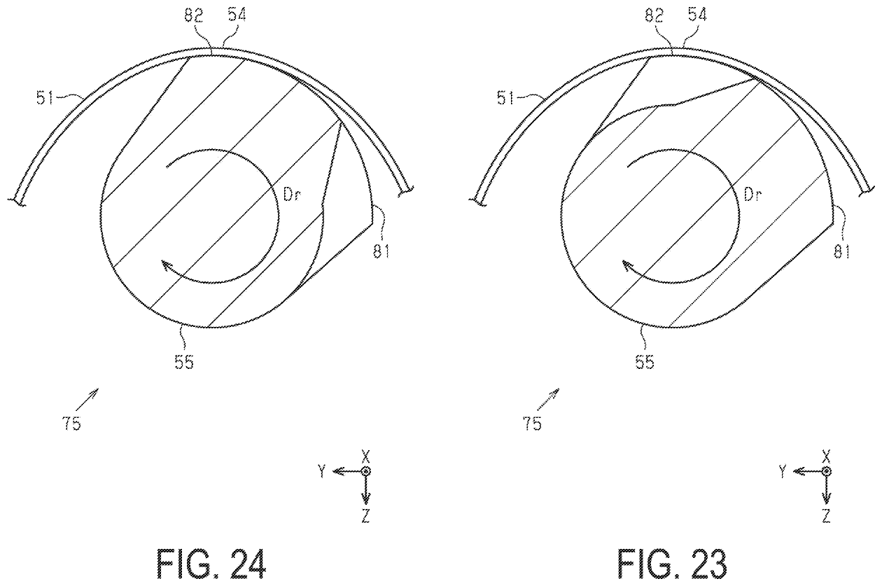

The cleaning unit 22 includes a rotation mechanism 84 that rotates the pressing unit 75. The pressing unit 75 is provided so as to be rotatable in the rotational direction Dr with the base portion 55 as an axis. The pressing unit 75 rotates in the rotational direction Dr from a reference state illustrated in FIG. 17 and FIG. 18, and returns to the reference state, after being in a first state illustrated in FIG. 19 and FIG. 20, a second state illustrated in FIG. 21 and FIG. 22, and a third state illustrated in FIG. 23 and FIG. 24.

As illustrated in FIG. 17 and FIG. 18, the first convex portion 81 and the second convex portion 82 are each provided at a part in the rotational direction Dr with the base portion 55 as the shaft so as to protrude radially from the base portion 55. The first convex portion 81 and the second convex portion 82 are provided shifted from each other, in the rotational direction Dr.

Next, actions of the present exemplary embodiment will be described.

When Detected Temperature is Equal to or Greater than Predetermined Temperature

As illustrated in FIG. 16 to FIG. 18, when a detected temperature detected by the temperature detection unit 33 is equal to or greater than a predetermined temperature, the cleaning unit 22 relatively moves the pressing unit 75 in the reference state with respect to the recording unit 20 in the cleaning direction Y1 to perform cleaning.

When the pressing unit 75 is in the reference state, a part of the absorbent member 51 pressed by the base portion 55 serves as the wiping part 54. As such, similar to Exemplary Embodiment 1 illustrated in FIG. 6, the cleaning unit 22 sets a distance in the ejecting direction Z between the first surface 71 and the pressing unit 75 to the first distance L1 to perform cleaning.

When Detected Temperature is Less than Predetermined Temperature

When a detected temperature is lower than a predetermined temperature, the cleaning unit 22 rotates the pressing unit 75, to align the first convex portion 81 and the second convex portion 82 with the upstream surface 79 and the downstream surface 80, respectively, in the ejecting direction Z.

As illustrated in FIG. 15, the cleaning unit 22 moves the pressing unit 75 in the cleaning direction Y1 to perform cleaning. As such, the pressing unit 75 sequentially moves to an upstream region Au aligned with the upstream surface 79 in the ejecting direction Z, a central stream region Ac aligned with the upstream surface 79 and the downstream surface 80 in the ejecting direction Z, and a downstream region Ad aligned with the downstream surface 80 in the ejecting direction Z.

As illustrated in FIG. 19 and FIG. 20, when moving in the upstream region Au, the cleaning unit 22 brings the pressing unit 75 into a first state. In the pressing unit 75 in the first state, the first convex portion 81 is located at an upper end of the pressing unit 75. Therefore, a part of the absorbent member 51 pressed by the first convex portion 81 serves as the wiping part 54. The second convex portion 82 is located below an upper end of the first convex portion 81.

The first convex portion 81 is aligned with the upstream surface 79 in the ejecting direction Z. Similar to Exemplary Embodiment 1 illustrated in FIG. 10, the cleaning unit 22 sets a distance in the ejecting direction Z from the upstream surface 79 to the first convex portion 81 to the second distance L2 to perform cleaning.

As illustrated in FIG. 21 and FIG. 22, when moving in the central stream region Ac, the cleaning unit 22 brings the pressing unit 75 into a second state. In the pressing unit 75 in the second state, the first convex portion 81 and the second convex portion 82 are located at the upper end of the pressing unit 75. Therefore, a part of the absorbent member 51 pressed by the first convex portion 81 and the second convex portion 82 serves as the wiping part 54.

The first convex portion 81 is aligned with the upstream surface 79 in the ejecting direction Z, and the second convex portion 82 is aligned with the downstream surface 80 in the ejecting direction Z. The cleaning unit 22 sets a distance in the ejecting direction Z from the upstream surface 79 to the first convex portion 81 to the second distance L2, and sets a distance in the ejecting direction Z from the downstream surface 80 to the second convex portion 82 to the second distance L2 to perform cleaning.

As illustrated in FIG. 23 and FIG. 24, when moving in the downstream region Ad, the cleaning unit 22 brings the pressing unit 75 into a third state. In the pressing unit 75 in the third state, the second convex portion 82 is located at the upper end of the pressing unit 75. Therefore, a part of the absorbent member 51 pressed by the second convex portion 82 serves as the wiping part 54. The first convex portion 81 is located below an upper end of the second convex portion 82. The second convex portion 82 is aligned with the downstream surface 80 in the ejecting direction Z. The cleaning unit 22 sets a distance in the ejecting direction Z from the downstream surface 80 to the second convex portion 82 to the second distance L2 to perform cleaning.

Effects of the present exemplary embodiment will now be described.

(10) The pressing unit 75 includes the first convex portion 81 and the second convex portion 82 that are provided shifted from each other, in the width direction X and the rotational direction Dr. As such, by rotating the pressing unit 75 in the rotational direction Dr, the first convex portion 81 and the second convex portion 82 can be aligned with the upstream surface 79 and the downstream surface 80, respectively. Thus, even when the recording unit 20 includes the upstream surface 79 and the downstream surface 80, the nozzle surface 36 can be cleaned well.

The present exemplary embodiment described above may be modified as follows. The present exemplary embodiment and modified examples thereof to be described below may be implemented in combination within a range in which a technical contradiction does not arise.

In Exemplary Embodiment 1 and Exemplary Embodiment 2, the second pressing unit 46 and the pressing unit 75 need not rotate. It is sufficient that the convex portion 56 and the nozzle surface 36 can at least sandwich the absorbent member 51, and the convex portion 56 may be provided at a part in the rotational direction Dr.

In Exemplary Embodiment 1, a diameter of the first pressing unit 48 may be the same as a diameter of the convex portion 56 of the second pressing unit 46.

The cleaning unit 22 may be configured to not include the absorbent member 51. The first pressing unit 48, the second pressing unit 46, and the pressing unit 75 may directly clean the nozzle surface 36.

In Exemplary Embodiment 3, one liquid ejecting head 58 may have one first surface 71. The pressing unit 75 may include the base portion 55 and the first convex portion 81. The cleaning unit 22, when a detected temperature is equal to or greater than a predetermined temperature, may perform cleaning in a reference state in which the base portion 55 is an upper end of the pressing unit 75, and when the detected temperature is lower than the predetermined temperature, may perform cleaning in a first state in which the first convex portion 81 is the upper end of the pressing unit 75.

The control unit 29 may move the cleaning unit 22 at a constant speed regardless of a detected temperature.

The control unit 29, when a detected temperature is equal to or greater than a predetermined temperature, may move the cleaning unit 22 at a faster speed than when the detected temperature is lower than the predetermined temperature.

In Exemplary Embodiment 1, a gap between the first pressing unit 48 and the second pressing unit 46 in the cleaning direction Y1 may be greater than a dimension of the nozzle surface 36 in the cleaning direction Y1. In this case, cleaning may be performed while the first pressing unit 48 and the second pressing unit 46 are located at the cleaning position CP.

The liquid receiving portion 39 may be provided separately from the cleaning unit 22. For example, the liquid receiving portion 39 may be provided at a position aligned with the cleaning unit 22 in the width direction X. The recording unit 20 may move in the width direction X from the maintenance position MP to perform flushing.

The cleaning direction Y1 may be a direction parallel to the X-axis.

The recording unit 20 may move along the X-axis to relatively move with respect to the cleaning unit 22, and cause the cleaning unit 22 to clean the nozzle surface 36. The recording unit 20 and the cleaning unit 22 may both move to clean the nozzle surface 36.

The temperature detection unit 33 may detect a temperature of the nozzle surface 36. The temperature detection unit 33 may detect a temperature of liquid in the recording unit 20. The temperature detection unit 33 may detect a temperature around the cleaning unit 22. The temperature detection unit 33 may detect an air temperature, which is a temperature of an environment in which the liquid ejecting device 11 is installed.

The liquid ejecting device 11 may be a liquid ejecting device that ejects or discharges other liquids other than ink. A state of liquid discharged from the liquid eject device as a small amount of droplets includes granules, tears, and string-like tails. The liquid described herein may be any material as long as the material can be ejected from the liquid ejecting device. For example, the liquid only needs to be a substance in a state of being in a liquid phase, and includes fluid bodies such as a liquid body with high or low viscosity, sol, gel water, other inorganic solvents, organic solvents, solutions, liquid resins, liquid metals, and metal melts. The liquid includes not only liquids as one state of a substance, but also particles of functional material consisting of solid substances such as pigments or metal particles that are dissolved, dispersed, or mixed in a solvent. Representative examples of liquids include inks, liquid crystals, and the like described in the above embodiments. Here, the inks include a general aqueous ink and a solvent ink, and various liquid compositions such as a gel ink, a hot-melt ink. For example, specific examples of the liquid ejecting device include, a device that ejects liquid including materials such as an electrode material and a color material used in manufacture of liquid crystal displays, electroluminescent displays, surface emitting displays, color filters and the like in a dispersed or dissolved form. The liquid ejecting device may be a device ejecting bioorganic substances used for biochip manufacturing, a device used as a precision pipette and ejecting liquid to be a sample, a printing apparatus, a micro dispenser, or the like. The liquid ejecting device may be a device ejecting lubricant to a precision machine such as a clock or a camera in a pinpoint manner, or a device ejecting a transparent resin liquid such as ultraviolet cure resin on a substrate for forming a tiny hemispherical lens, optical lens, or the like used for an optical communication element and the like. The liquid ejecting device may be a device that ejects an etching solution, such as an acid or alkali, to etch a substrate or the like.

Hereinafter, technical concepts and effects thereof that are understood from the above-described exemplary embodiments and modified examples will be described.

(A) A liquid ejecting device includes a recording unit configured to eject liquid onto a medium in a ejecting direction from a nozzle provided at a nozzle surface to perform recording, a cleaning unit including a pressing unit for cleaning the nozzle surface, and a temperature detection unit configured to detect temperature, wherein the nozzle surface includes a first surface in which the nozzle opens, and a second surface located between the first surface and the pressing unit in the ejecting direction, and the cleaning unit is configured to perform the cleaning with a distance in the ejecting direction from the first surface to the pressing unit set to a first distance when a detected temperature detected by the temperature detection unit is equal to or greater than a predetermined temperature, and to a second distance shorter than the first distance when the detected temperature is lower than the predetermined temperature.

According to this configuration, the nozzle surface includes the first surface and the second surface. The second surface is located between the first surface and the pressing unit in the ejecting direction. The first surface located at a position separated from the pressing unit is less likely to be cleaned by the pressing unit compared to the second surface. In that regard, the cleaning unit, when the detected temperature is lower than the predetermined temperature, sets a distance from the first surface to the pressing unit to be shorter than when the detected temperature is equal to or greater than the predetermined temperature. In other words, when the detected temperature is low and viscosity of liquid is high, the pressing unit approaches the first surface to clean the first surface. Thus, cleaning can be performed well even when temperature changes.

(B) In the liquid ejecting device, the pressing unit includes a base portion and a convex portion that protrudes with respect to the base portion, and when the detected temperature is lower than the predetermined temperature, the cleaning unit may locate the convex portion at a position that is between the first surface and the base portion in the ejecting direction, and that is a position aligned with the first surface in the ejecting direction.

According to this configuration, when the detected temperature is lower than the predetermined temperature, the convex portion included in the pressing unit, and the first surface included in the nozzle surface are aligned in the ejecting direction. At this time, the convex portion is located at a position between the first surface and the base portion in the ejecting direction. Thus, a distance from the first surface to the convex portion in the ejecting direction is shorter than a distance from the first surface to the base portion. Therefore, a distance between the first surface and the pressing unit can be easily shortened.

(C) In the liquid ejecting device, the cleaning unit includes a first pressing unit formed in a cylindrical shape, and a second pressing unit that is the pressing unit, and when the detected temperature is equal to or greater than the predetermined temperature, the first pressing unit cleans the nozzle surface, and when the detected temperature is lower than the predetermined temperature, the second pressing unit may clean the nozzle surface.

According to this configuration, the cleaning unit includes the first pressing unit and the second pressing unit. The cleaning unit can selectively use the first pressing unit and the second pressing unit in accordance with the detected temperature to perform cleaning well.

(D) In the liquid ejecting device, the cleaning unit further includes a liquid receiving portion configured to receive the liquid ejected from the nozzle in association with flushing, and moves the first pressing unit, the second pressing unit, and the liquid receiving portion in a cleaning direction to clean the nozzle surface, and the first pressing unit may be located between the second pressing unit and the liquid receiving portion in the cleaning direction.

According to this configuration, in the cleaning direction, an interval between the first pressing unit that performs cleaning when a detected temperature is equal to or greater than a predetermined temperature and the liquid receiving portion is set to be less than an interval between the second pressing unit that performs cleaning when the detected temperature is lower than the predetermined temperature and the liquid receiving portion. In other words, by providing the first pressing unit at a position close to the liquid receiving portion, the liquid receiving portion can be caused to quickly face the nozzle surface after the nozzle surface is cleaned by the first pressing unit, and the recording unit can be caused to perform flushing.

(E) In the liquid ejecting device, the cleaning unit includes a first pressing unit and a second pressing unit that is the pressing unit, and each of the first pressing unit and the second pressing unit is configured to be movable to a cleaning position where the nozzle surface can be cleaned, and to an retracted position where the pressing unit is retracted from the cleaning position, and when the detected temperature is equal to or greater than the predetermined temperature, the cleaning unit locates the first pressing unit at the cleaning position and locates the second pressing unit at the retracted position to clean the nozzle surface, and when the detected temperature is lower than the predetermined temperature, the cleaning unit may locate the first pressing unit at the retracted position and locate the second pressing unit at the cleaning position to clean the nozzle surface.

According to this configuration, when the first pressing unit is located at the cleaning position, the second pressing unit is located at the retracted position. When the first pressing unit is located at the retracted position, the second pressing unit is located at the cleaning position. As a result, one of the first pressing unit and the second pressing unit, which is located at the cleaning position, can be used to perform cleaning. Thus, a load on the nozzle surface can be reduced compared to when both the first pressing unit and the second pressing unit are located at the cleaning position to perform cleaning.

(F) In the liquid ejecting device, when the detected temperature is equal to or greater than the predetermined temperature, the cleaning unit may locate the base portion at a position aligned with the first surface in the ejecting direction.

According to this configuration, when the detected temperature is equal to or greater than the predetermined temperature, the base portion included in the pressing unit, and the first surface included in the nozzle surface are aligned in the ejecting direction. In other words, depending on whether the base portion or the convex portion is located at a position aligned with the first surface in the ejecting direction, the pressing unit can change a distance from the first surface in the ejecting direction. Thus, a distance between the first surface and the cleaning unit can be changed by one pressing unit.

(G) In the liquid ejecting device, the base portion and the convex portion are aligned in a width direction, and the pressing unit may be provided so as to be movable in the width direction.

According to this configuration, the pressing unit is provided so as to be movable in the width direction in which the base portion and the convex portion are aligned. For example, by moving the pressing unit in the width direction in a state in which the first surface and the convex portion are aligned in the ejecting direction, the convex portion is moved from a position aligned with the first surface, and the base portion can be moved to a position aligned with the first surface. Therefore, a distance between the first surface and the pressing unit can be easily changed.

(H) In the liquid ejecting device, when the detected temperature is equal to or greater than the predetermined temperature, the cleaning unit relatively moves the pressing unit and the recording unit at a first speed to perform the cleaning, and when the detected temperature is lower than the predetermined temperature, the cleaning unit relatively moves the pressing unit and the recording unit at a second speed to perform the cleaning, and the first speed may be slower than the second speed.

Liquid is more likely to flow when temperature is high, compared to when temperature is low. According to this configuration, when a detected temperature is equal to or greater than a predetermined temperature, the cleaning unit relatively moves the pressing unit and the recording unit at the first speed that is slower than the second speed to perform cleaning. Thus, even in a case of cleaning performed while a distance between the first surface and the pressing unit is set to a first distance that is longer than a second distance, the cleaning can be performed while waiting for liquid adhering to the first surface to move.

(I) In the liquid ejecting device, the recording unit includes the plurality of first surfaces, the plurality of first surfaces are provided shifted from each other in a width direction and a cleaning direction, the pressing unit includes a base portion formed in a cylindrical shape, and a plurality of convex portions protruding with respect to the base portion, and is provided so as to be rotatable in a rotational direction with the base portion as an axis, the plurality of convex portions are provided shifted from each other in the width direction and the rotational direction, and the cleaning unit relatively moves the pressing unit with respect to the recording unit in the cleaning direction to perform the cleaning, and when the detected temperature is lower than the predetermined temperature, may rotate the pressing unit to align the plurality of convex portions with the plurality of first surfaces, respectively, in the ejecting direction.

According to this configuration, the pressing unit includes the plurality of convex portions provided shifted from each other in the width direction and the rotational direction. As such, by rotating the pressing unit in the rotational direction, the plurality of convex portions can be aligned to the plurality of first surfaces, respectively. Thus, even when the recording unit includes the plurality of first surfaces, the nozzle surface can be cleaned well.

(J) The liquid ejecting device further includes an absorbent member that can contact the nozzle surface and absorb the liquid, and the cleaning unit may sandwich the absorbent member between the pressing unit and the nozzle surface to perform the cleaning.

According to this configuration, the absorbent member is capable of absorbing the liquid. Thus, by sandwiching the absorbent member between the cleaning unit and the recording unit to perform cleaning, liquid adhering to the nozzle surface can be absorbed, and liquid remaining on the nozzle surface can be reduced.

What is claimed is:

1. A liquid ejecting device, comprising:
a recording unit configured to eject liquid onto a medium in a ejecting direction from a nozzle provided at a nozzle surface to perform recording;
a cleaning unit including a pressing unit for cleaning the nozzle surface; and
a temperature detection unit configured to detect temperature, wherein
the nozzle surface includes
a first surface in which the nozzle opens, and
a second surface located downstream the first surface in the ejecting direction, and
the cleaning unit is configured to perform the cleaning with a distance in the ejecting direction from the first surface to the pressing unit set
to a first distance when a detected temperature detected by the temperature detection unit is equal to or greater than a predetermined temperature, and
to a second distance shorter than the first distance when the detected temperature is lower than the predetermined temperature.

2. The liquid ejecting device according to claim 1, wherein
the pressing unit includes a base portion, and a convex portion protruding with respect to the base portion, and
when the detected temperature is lower than the predetermined temperature, the cleaning unit locates the convex portion at a position that is between the first surface and the base portion in the ejecting direction, and that is aligned with the first surface in the ejecting direction.

3. The liquid ejecting device according to claim 2, wherein
the cleaning unit includes a first pressing unit formed in a cylindrical shape, and a second pressing unit that is the pressing unit, and
when the detected temperature is equal to or greater than the predetermined temperature, the first pressing unit cleans the nozzle surface, and
when the detected temperature is lower than the predetermined temperature, the second pressing unit cleans the nozzle surface.

4. The liquid ejecting device according to claim 3, wherein
the cleaning unit
further includes a liquid receiving portion configured to receive the liquid ejected from the nozzle in association with flushing, and
moves the first pressing unit, the second pressing unit, and the liquid receiving portion in a cleaning direction to clean the nozzle surface, and
the first pressing unit is located between the second pressing unit and the liquid receiving portion in the cleaning direction.

5. The liquid ejecting device according to claim 1, wherein
the cleaning unit includes a first pressing unit, and a second pressing unit that is the pressing unit, and
each of the first pressing unit and the second pressing unit is configured to move to a cleaning position where the nozzle surface is cleanable, and to an retracted position where the pressing unit is retracted from the cleaning position,
when the detected temperature is equal to or greater than the predetermined temperature, the cleaning unit locates the first pressing unit at the cleaning position and locates the second pressing unit at the retracted position to clean the nozzle surface, and
when the detected temperature is lower than the predetermined temperature, the cleaning unit locates the first pressing unit at the retracted position and locates the second pressing unit at the cleaning position to clean the nozzle surface.

6. The liquid ejecting device according to claim 2, wherein
when the detected temperature is equal to or greater than the predetermined temperature, the cleaning unit locates the base portion at a position aligned with the first surface in the ejecting direction.

7. The liquid ejecting device according to claim 6, wherein
the base portion and the convex portion are aligned in a width direction, and
the pressing unit is provided movably in the width direction.

8. The liquid ejecting device according to claim 6, wherein
when the detected temperature is equal to or greater than the predetermined temperature, the cleaning is performed by the relative movement of the pressing unit and the recording unit at a first speed,
when the detected temperature is lower than the predetermined temperature, the cleaning is performed by the relative movement of the pressing unit and the recording unit at a second speed, and
the first speed is slower than the second speed.

9. The liquid ejecting device according to claim 1, wherein
the recording unit includes a plurality of the first surfaces,
the plurality of first surfaces are provided shifted from each other in a width direction and a cleaning direction,
the pressing unit includes a base portion formed in a cylindrical shape, and a plurality of convex portions protruding with respect to the base portion, and is provided rotatably in a rotational direction with the base portion as an axis,
the plurality of convex portions are provided shifted from each other in the width direction and the rotational direction, and
the cleaning unit
relatively moves the pressing unit with respect to the recording unit in the cleaning direction to perform the cleaning, and
when the detected temperature is lower than the predetermined temperature, rotates the pressing unit to align the plurality of convex portions with the plurality of first surfaces, respectively, in the ejecting direction.

10. The liquid ejecting device according to claim 1, further comprising:
an absorbent member configured to contact the nozzle surface and absorb the liquid, wherein
the cleaning unit performs the cleaning with the absorbent member sandwiched between the pressing unit and the nozzle surface.
